(19) United States
(12) Patent Application Publication
(10) Pub. No.: US 2026/0095930 A1
(43) Pub. Date: Apr. 2, 2026

(54) DATA FLOW PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN)

(73) Assignee: Beijing Xiaomi Mobile Software Co., Ltd., Beijing (CN)

(21) Appl. No.: 19/112,129

(22) PCT Filed: Sep. 16, 2022
(86) PCT No.: PCT/CN2022/119475

§ 371 Date: Mar. 14, 2025

(51) Int. Cl. H04W 72/51; H04W 28/02; H04W 72/543

(52) U.S. Cl. CPC H04W 72/51; H04W 28/0236; H04W 72/543

(57) ABSTRACT

Embodiments of the present invention provide a data flow processing method. The method is performed by a terminal. The method comprises: sending capability indication information to a first network function, wherein the capability indication information is used for indicating that the terminal supports or does not support a second network function to perform a predetermined operation on a data flow of a predetermined service on the basis of a prediction result, and the predetermined operation comprises at least one of the following: optimal scheduling; and flow control. Compared with not using the mode of sending the capability indication information, the present invention can adapt to the transmission status of a data flow, improve the transmission efficiency of the data flow, and mitigate congestion, thereby improving the user experience.

### CROSS REFERENCE TO RELATED APPLICATIONS

This application is a US National Phase of a PCT Application No. PCT/CN2022/119475 filed on Sep. 16, 2022, the entire contents of which are incorporated herein by reference in their entireties.

### TECHNICAL FIELD

The present disclosure relates to the field of wireless communication technology, but is not limited to the field of wireless communication technology, and particularly relates to data flow processing methods and apparatuses, communication devices, and storage media.

### BACKGROUND

With the development of wireless networks, wireless communication systems adopt Quality of Service (QoS) mechanisms. In an application scenario, service data flow has characteristics of high bandwidth, low latency, and high reliability requirements, which require matching the QoS requirements of data units and datasets in the data flow to enhance user experience. In related arts, when network congestion occurs, the scheduling mechanism of data flow cannot effectively alleviate the congestion, which will result in the QoS of the service not being met, affecting the user experience.

### SUMMARY

The embodiments of the present disclosure disclose data flow processing methods and apparatuses, communication devices, and storage media.

According to the first aspect of the embodiments of the present disclosure, a data flow processing method is provided, where the method is performed by a terminal, and the method includes: transmitting capability indication information to a first network function. Where the capability indication information is configured to indicate whether the terminal supports or does not support a second network function to perform a predetermined operation on data flow of a predetermined service based on a prediction result, and where the predetermined operation includes at least one of: scheduling optimizing, or volume controlling.

In an embodiment, transmitting the capability indication information to the first network function includes: transmitting the capability indication information to the first network function in a Packet Data Unit (PDU) session establishment procedure; or, transmitting the capability indication information to the first network function in a PDU session modification procedure.

In an embodiment, transmitting the capability indication information to the first network function includes: transmitting parameter information of a Session Management Core Network (5GSM Core Network) capability carrying the capability indication information to the first network function; or, transmitting parameter information of a Protocol Configuration Option (PCO) carrying the capability indication information to the first network function; where the first network function includes a Session Management Function (SMF).

In an embodiment, transmitting the capability indication information to the first network function via a Session Management Function (SMF); where the first network function includes a Policy Control Function (PCF).

In an embodiment, the predetermined service includes an Extended Reality and Media (XRM) service or a multimodal service.

In an embodiment, the first network function includes a Policy Control Function (PCF) or a Session Management Function (SMF); and the second network function includes a User Plane Function (UPF).

In an embodiment, transmitting the capability indication information to the first network function includes: transmitting the capability indication information to the first network function via a base station and a third network function.

In an embodiment, the third network function includes an Access and Mobility Management Function (AMF).

According to the second aspect of the embodiments of the present disclosure, a data flow processing method is provided, where the method is performed by a first network function, and the method includes: receiving capability indication information transmitted by a terminal. Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, receiving the capability indication information transmitted by the terminal includes: receiving the capability indication information transmitted by the terminal in a Packet Data Unit (PDU) session establishment procedure; or, receiving the capability indication information transmitted by the terminal in a PDU session modification procedure.

In an embodiment, receiving the capability indication information transmitted by the terminal includes: receiving parameter information of a Session Management Core Network (SM CN) capability carrying the capability indication information transmitted by the terminal; or, receiving parameter information of a Protocol Configuration Option (PCO) carrying the capability indication information transmitted by the terminal; where the first network function includes a Session Management Function (SMF).

In an embodiment, receiving the capability indication information transmitted by the terminal via a Session Management Function (SMF); where the first network function includes a Policy Control Function (PCF).

In an example, the method further includes: generating policy rule information based on the capability indication information; where the policy rule information is configured to perform the predetermined operation.

In an example, the method further includes: performing the predetermined operation based on the policy rule information.

In an example, the method further includes: transmitting at least one of following information to the second network function: filtering rule information; usage monitoring rule information; policy rule information; or Quality of Service (QoS) rule information.

In an embodiment, the second network function includes a user plane function (UPF).

In an embodiment, the predetermined service includes an Extended Reality and Media (XRM) service or a multimodal service.

In an embodiment, the first network function includes a Policy Control Function (PCF) or a Session Management Function (SMF); and the second network function includes a User Plane Function (UPF).

In an embodiment, receiving the capability indication information transmitted by the terminal includes: receiving the capability indication information transmitted by the terminal via a base station and a third network function.

In an embodiment, the third network function includes an Access and Mobility Management Function (AMF).

According to the third aspect of the embodiments of the present disclosure, a data flow processing method is provided, where the method is performed by a second network function, and the method includes: receiving policy rule information transmitted by a first network function. Where the policy rule information is configured to perform a predetermined operation on data flow of a predetermined service based on a prediction result; where the predetermined operation includes at least one of: scheduling optimizing, or volume controlling.

In an example, the method further includes: performing the predetermined operation based on the policy rule information.

In an embodiment, performing the predetermined operation based on the policy rule information includes: performing the predetermined operation at a granularity of predetermined units. Where the predetermined units include data flow, PDU sets, or data packets.

In an embodiment, performing the predetermined operation based on the policy rule information includes at least one of: performing the predetermined operation within a predetermined time window; performing the predetermined operation in response to determining that volume of the data flow is greater than a volume threshold; or performing the predetermined operation in response to determining that a packet loss rate is greater than a packet loss rate threshold.

In an embodiment, the prediction result is a prediction analysis result of a network data analytic function (NWDAF) and/or an event notification result reported by a radio access network.

According to the fourth aspect of the embodiments of the present disclosure, a data flow processing system is provided, where the system includes a first network function and a second network function; where the first network function performs any one of the methods performed by the first network function in the present disclosure; and the second network function performs any one of the methods performed by the second network function in the present disclosure.

According to the fifth aspect of the embodiments of the present disclosure, a data flow processing apparatus is provided, and includes: a transmitting module, configured to transmit capability indication information to a first network function. Where the capability indication information is configured to indicate whether the terminal supports or does not support a second network function to perform a predetermined operation on data flow of a predetermined service based on a prediction result, and where the predetermined operation includes at least one of: scheduling optimizing, or volume controlling.

According to the sixth aspect of the embodiments of the present disclosure, a data flow processing apparatus is provided, and includes: a receiving module, configured to receive capability indication information transmitted by a terminal. Where the capability indication information is configured to indicate whether the terminal supports or does not support a second network function to perform a predetermined operation on data flow of a predetermined service based on a prediction result, and where the predetermined operation includes at least one of: scheduling optimizing, or volume controlling.

According to the seventh aspect of the embodiments of the present disclosure, a data flow processing apparatus is provided, and includes: a receiving module, configured to receive policy rule information transmitted by a first network function. Where the policy rule information is configured to perform a predetermined operation on data flow of a predetermined service based on a prediction result, and where the predetermined operation includes at least one of: scheduling optimizing, or volume controlling.

According to the eighth aspect of the embodiments of the present disclosure, a communication device is provided, and includes: one or more processors; and one or more memories storing instructions executable by the one or more processors. Where the one or more processors are configured to execute the executable instructions to implement the method according to any one of the embodiments of the present disclosure.

According to the ninth aspect of the present disclosure, a computer storage medium is provided, which stores a computer executable program, where when the executable program is performed by one or more processors, the method according to any one of the embodiments of the present disclosure is implemented.

In the embodiments of the present disclosure, the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Here, since the terminal transmits the capability indication information to the first network function indicating whether the terminal supports or does not support the second network function to perform the predetermined operation on the data flow of the predetermined service based on the prediction result, the first network function can determine whether the terminal supports or does not support the second network function to perform the predetermined operation on the data flow of the predetermined service based on the prediction result after receiving the capability indication information. When the terminal supports the second network function to perform the predetermined operation on the data flow of the predetermined service based on the prediction result, scheduling optimizing and/or volume controlling can be performed, which, compared to the method of not transmitting the capability indication information, can adapt to the transmission status of the data flow, improve the transmission efficiency of the data flow, and alleviate congestion, thus enhancing the user experience.

### BRIEF DESCRIPTION OF DRAWINGS

FIG. 1 is a schematic structural diagram of a wireless communication system according to an embodiment.

FIG. 2 is a flowchart of a data flow processing method according to an embodiment.

FIG. 3 is a flowchart of a data flow processing method according to an embodiment.

FIG. 4 is a flowchart of a data flow processing method according to an embodiment.

FIG. 5 is a flowchart of a data flow processing method according to an embodiment.

FIG. 6 is a flowchart of a data flow processing method according to an embodiment.

FIG. 7 is a flowchart of a data flow processing method according to an embodiment.

FIG. 8 is a flowchart of a data flow processing method according to an embodiment.

FIG. 9 is a flowchart of a data flow processing method according to an embodiment.

FIG. 10 is a flowchart of a data flow processing method according to an embodiment.

FIG. 11 is a flowchart of a data flow processing method according to an embodiment.

FIG. 12 is a flowchart of a data flow processing method according to an embodiment.

FIG. 13 is a flowchart of a data flow processing method according to an embodiment.

FIG. 14 is a flowchart of a data flow processing method according to an embodiment.

FIG. 15 is a schematic diagram of a data flow processing system according to an embodiment.

FIG. 16 is a schematic diagram of a data flow processing apparatus according to an embodiment.

FIG. 17 is a schematic diagram of a data flow processing apparatus according to an embodiment.

FIG. 18 is a schematic diagram of a data flow processing apparatus according to an embodiment.

FIG. 19 is a schematic structural diagram of a terminal according to an embodiment.

FIG. 20 is a block diagram of a base station according to an embodiment.

### DETAILED DESCRIPTION

Embodiments will be described in detail here with the examples thereof expressed in the drawings. When the following descriptions involve the drawings, like numerals in different drawings represent like or similar elements unless stated otherwise. The embodiments described in the following examples do not represent all embodiments consistent with the present disclosure. Instead, they are merely examples of methods, apparatuses and devices consistent with certain aspects of the disclosure, as detailed in the appended claims.

The term used in the embodiments of the present disclosure is for the purpose of describing particular examples only and is not intended to limit the embodiments of the present disclosure. As used in embodiments of the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “at the time of”, “when” or “in response to determining”.

For the purpose of simplicity and ease of understanding, the terms used in the present disclosure to represent comparison are “greater than”, “less than”. But for those skilled in the art, it can be understood that the term “greater than” also encompasses the meaning of “greater than or equal to”, “less than”also encompasses the meaning of “less than or equal to”.

Referring to FIG. 1, a schematic structural diagram of a wireless communication system according to an embodiment is illustrated. As shown in FIG. 1, the wireless communication system is a communication system based on mobile communication technology. The wireless communication system can include several user devices 110 (also referred to as terminal devices 110, or terminals 110) and several base stations 120 (also referred to as access network devices 120).

Where user devices 110 may be devices providing voice and/or data connectivity to users. The user device 110 can communicate with one or more core networks via a Radio Access Network (RAN). The user device 110 can be an IoT (Internet of Things) user device, such as a sensor device, a mobile phone, or a computer with an IoT user device. For example, the user device 110 can be a fixed, portable, pocket-sized, handheld, computer-built-in, or vehicle-mounted device, such as a station (STA), a subscriber unit, a subscriber station, a mobile station, a mobile, a remote station, an access point, a remote terminal, an access terminal, a user terminal, a user agent, a user device, or a user equipment. Or, the user device 110 may also be an unmanned aerial vehicle device. Or, the user device 110 can also be a vehicle-mounted device, such as a trip computer with a wireless communication capability, or a wireless user device with a trip computer externally connected. Or, the user device 110 can be an infrastructure, such as a street light, a signal light or other infrastructures with wireless communication capabilities and the like.

The base stations 120 may be network side devices in the wireless communication system. The wireless communication system may be a 4th generation mobile communication (4G) system, also referred to as a Long-Term Evolution (LTE) system, or the wireless communication system may be a 5G system, also referred to as a New Radio (NR) system or 5G NR system. Or, the wireless communication system may be a next-generation system to the 5G system. One of the access networks in the 5G system can be referred to as the NG-RAN (New Generation-Radio Access Network).

The base stations 120 can be evolved base stations (eNBs) as adopted in 4G systems. Or, the base stations 120 can also be base stations (gNBs) in a 5G system with a centralized and distributed architecture. When the base stations 120 adopt the centralized and distributed architecture, a central unit (CU) and at least two distributed units (DU) are usually included. A Packet Data Convergence Protocol (PDCP) layer, a Radio Link Control (RLC) layer, and a Media Access Control (MAC) layer protocol stack are provided in the central unit; a physical (PHY) layer protocol stack is provided in the distributed unit, and embodiments of the present disclosure do not limit the specific implementation of the base stations 120.

The base station 120 and the user device 110 can be connected to each other via a wireless air interface. In different implementations, the wireless air interfaces may be wireless air interfaces based on the fourth generation mobile communication network technology (4G) standard; or, the wireless air interfaces may be wireless air interfaces based on the fifth generation mobile communication network technology (5G) standard, for example, the wireless air interfaces may be New Radios; or, the wireless air interfaces may also be wireless air interfaces based on the next generation mobile communication network technology standard of 5G.

In some embodiments, an E2E (End to End) connection may also be established between the user devices 110. For example, in vehicle to everything (V2X) communication scenarios, such as V2V (vehicle to vehicle) communication, V2I (vehicle to infrastructure) communication, V2P (vehicle to pedestrian) communication and the like.

Here, the user device can be considered as the terminal device in the following embodiments.

In some embodiments, the wireless communication system may also include a network management device 130.

Several base stations 120 each are connected to the network management device 130. Where the network management device 130 can be a core network device in a wireless communication system, such as a core network device in a 5G network. It should be noted that different core network devices can also correspond to different network functions. The embodiments of the present disclosure do not limit the form in which the network management devices 130 can be implemented.

In order to facilitate the understanding of those skilled in the art, multiple implementation methods are provided in the embodiments of the present disclosure to clearly illustrate the technical solutions of the present disclosure. Those skilled in the art can understand that each of the multiple implementation methods provided in the embodiments of the present disclosure can be executed separately, can be combined with the methods of other embodiments in the present disclosure, can be executed in combination with some methods in other related technologies, or can be executed in combination with the methods of other embodiments in the present disclosure and some methods in other related technologies, which is not limited in the embodiments of the present disclosure.

In order to better understand the technical solution described in any one of the embodiments of the present disclosure, the application scenarios in the relevant technologies will be explained below.

Mobile media services, extended reality (XR) services through cloud such as augmented reality (AR) services, virtual reality (VR) services, etc., cloud gaming, and video-based machine or drone remote controlling services are expected to contribute increasingly high volume to 5G networks.

In addition to audio and video streaming, XR services further involves multimodal data flow, such as data flow for biological tactile perception. These multimodal data describe data input from the same device or different devices (including sensors) for the same service or application, and these data may be output to one or more destination device terminals. The various data flow in multimodal data often have certain or even strong correlations, such as synchronization of audio and video streams, synchronization of touch and vision, etc. The data flow of this type of media service themselves, various data flow, and the network transmission requirements of data flow for these services all have some common characteristics. The effective identification and utilization of these characteristics will be more helpful for the transmission and control of networks and services, as well as for service security and user experience.

However, the 5G system adopts a universal QoS mechanism to handle various data services, including XR services, without fully considering the characteristics of XR media services, and cannot effectively support differentiated uplink and downlink requirements, such as asymmetric requirements for uplink data reliability and downlink data bandwidth. At the same time, XR media data flow have characteristics of high bandwidth, low latency, and high reliability requirements, which require matching the QoS requirements of data units and datasets in the data flow (such as the dependency relationships between data units in the dataset, the dependency relationships between datasets, the importance (priority) of data units in the dataset, and the importance (priority) of datasets), in order to effectively enhance the user experience.

At the same time, the characteristics of Extended Reality and Media (XRM) services with high bandwidth and low latency requirements pose new challenges to the data scheduling and transmission via radio access network air interfaces. In the 5G system, it is researched how to optimize the data scheduling of radio access network air interfaces based on information such as the dependency relationships and importance priorities between data units in the dataset. However, when network congestion occurs, the scheduling mechanism for data flow still cannot quickly alleviate the congestion. During the congestion process, data units exceeding the QoS latency threshold are discarded, which directly leads to the inability to meet the QoS for the service and a decrease in Quality of Experience (QoE). In related arts, 5G systems do not yet support data flow for the XR service, especially network side scheduling enhancements for downlink data flow.

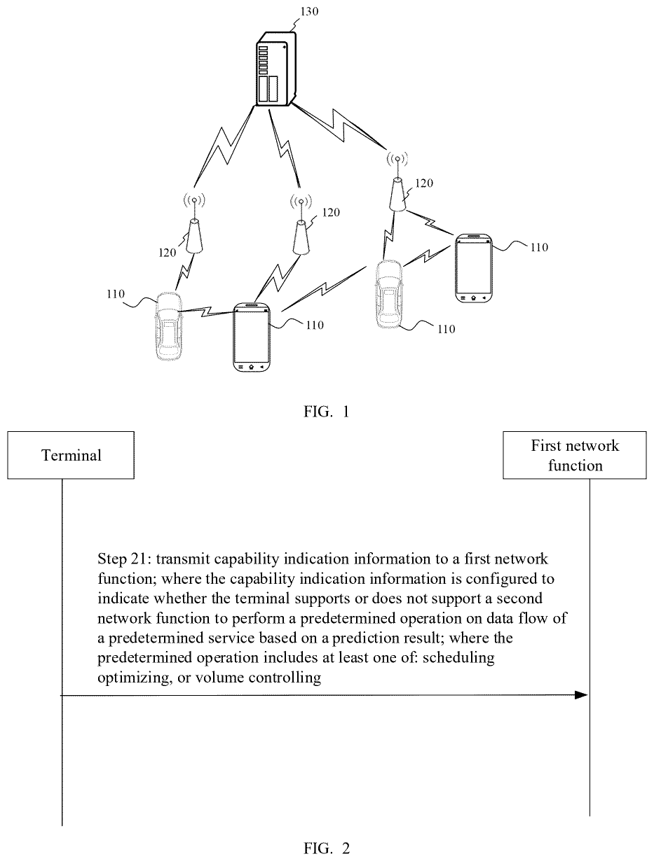

As shown in FIG. 2, this embodiment provides a data flow processing method, where the method is performed by a terminal, and the method includes step 21.

In step 21, capability indication information is transmitted to a first network function. Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network device referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in a core network. For example, the first network function can be a Session Management Function (SMF) or a Policy Control Function (PCF), the second network function can be a User Plane Function (UPF), and the third network function can be an Access and Mobility Management Function (AMF). The network function can also be other evolved network functions, which is not limited here.

In an embodiment, the predetermined service includes an Extended Reality and Media (XRM) service or a multimodal service.

In an embodiment, the prediction result may be a size of a predicted amount of data to be transmitted or that needs to be transmitted within a predetermined period of time. It should be noted that when the size of the predicted amount of data exceeds the set threshold, scheduling optimizing and/or volume controlling need to be performed to improve the transmission efficiency of the data flow and alleviate congestion. In some embodiments, when the size of the predicted amount of data is smaller than the set threshold, scheduling optimizing and/or volume controlling may not be performed.

In an embodiment, the prediction result may be the prediction analysis result of Network Data Analytic Function (NWDAF). Alternatively, the prediction result may also be the event notification result reported by the radio access network.

In an embodiment, scheduling optimizing may prioritize scheduling data flow with an importance level greater than a level threshold. For example, if the data flow includes a first data flow and a second data flow, and the importance level of the first data flow is greater than the importance level of the second data flow, in the event of network congestion, the first data flow can be prioritized for scheduling. In some embodiments, scheduling optimizing can also include other methods, such as discarding unimportant packets and increasing transmission resources, which is not limited here.

In an embodiment, volume controlling may include controlling the volume of data flow when network congestion occurs. For example, when the congestion degree is greater than a degree threshold, the volume of the transmitted data flow is decreased. When the congestion degree is less than the degree threshold, the volume of the transmitted data flow is increased. In some embodiments, volume controlling can also include other methods. For example, when congestion occurs, active packet dropping can be triggered.

In an embodiment, the capability indication information is transmitted to the first network function, where the capability indication information is configured to indicate whether the terminal supports or does not support a second network function to perform a predetermined operation on downlink data flow of a predetermined service based on a prediction result; where the predetermined operation includes at least one of: scheduling optimizing, or volume controlling.

In an embodiment, the capability indication information is transmitted to the first network function via the base station and the third network function; where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, the capability indication information is transmitted to the first network function during the session procedure, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. It should be noted that transmitting the indication information to the first network function in the session establishment or session modification procedure of the session procedure requires transmitting the indication information from the radio access network to the first network function via the third network function. Here, the first network function may be SMF, and the third network function may be AMF.

In an embodiment, the capability indication information is transmitted to the first network function in the packet data unit (PDU) session establishment procedure, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, the capability indication information is transmitted to the first network function in a PDU session modification procedure. Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the PDU session procedure, parameter information of a session management core network (SM CN, 5GSM Core Network) capability carrying the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling; where the first network function includes a Session Management Function (SMF).

In an embodiment, in the PDU session procedure, parameter information of Protocol Configuration Options (PCO) carrying the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling; where the first network function includes a Session Management Function (SMF).

In an embodiment, the capability indication information is transmitted to the first network function via the Session Management Function (SMF); where the first network function includes the Policy Control Function (PCF), where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. The PCF can formulate polices but not limited to polices for executing predetermined operations based on the capability indication information.

In the embodiments of the present disclosure, the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Here, since the terminal transmits the capability indication information to the first network function indicating whether the terminal supports or does not support the second network function to perform the predetermined operation on the data flow of the predetermined service based on the prediction result, the first network function can determine whether the terminal supports or does not support the second network function to perform the predetermined operation on the data flow of the predetermined service based on the prediction result after receiving the capability indication information. When the terminal supports the second network function to perform the predetermined operation on the data flow of the predetermined service based on the prediction result, scheduling optimizing and/or volume controlling can be performed, which, compared to the method of not transmitting the capability indication information, can adapt to the transmission status of the data flow, improve the transmission efficiency of the data flow, and alleviate congestion, thus enhancing the user experience.

It should be noted that those skilled in the art can understand that the methods provided in embodiments of the present disclosure can be executed separately or together with some methods in embodiments of the present disclosure or related arts.

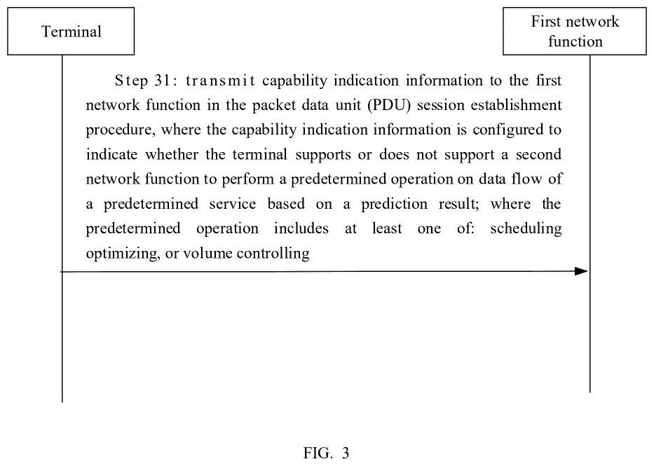

As shown in FIG. 3, this embodiment provides a data flow processing method, where the method is performed by a terminal, and the method includes step 31.

In step 31, capability indication information is transmitted to the first network function in the packet data unit (PDU) session establishment procedure, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the PDU session establishment procedure, the parameter information of the session management core network (SM CN) capability carrying the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In order to better understand the embodiments of the present disclosure, the following will further illustrate the present disclosure through an embodiment.

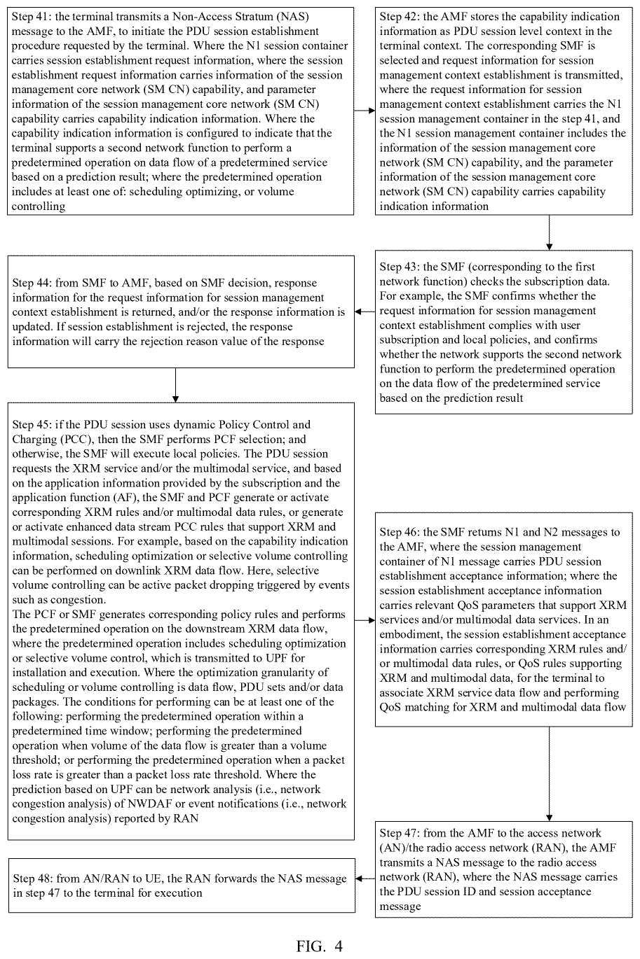

Referring to FIG. 4, in this embodiment, a data flow processing method is provided, which includes steps 41 to 48.

In step 41, the terminal transmits a Non-Access Stratum (NAS) message to the AMF, to initiate the PDU session establishment procedure requested by the terminal. Where the N1 session container carries session establishment request information, where the session establishment request information carries information of the session management core network (SM CN) capability, and parameter information of the session management core network (SM CN) capability carries capability indication information. Where the capability indication information is configured to indicate that the terminal supports a second network function to perform a predetermined operation on data flow of a predetermined service based on a prediction result; where the predetermined operation includes at least one of: scheduling optimizing, or volume controlling.

In step 42, the AMF stores the capability indication information as PDU session level context in the terminal context. The corresponding SMF is selected and request information for session management context establishment is transmitted, where the request information for session management context establishment carries the N1 session management container in the step 41, and the N1 session management container includes the information of the session management core network (SM CN) capability, and the parameter information of the session management core network (SM CN) capability carries capability indication information.

In step 43, the SMF (corresponding to the first network function) checks the subscription data. For example, the SMF confirms whether the request information for session management context establishment complies with user subscription and local policies, and confirms whether the network supports the second network function to perform the predetermined operation on the data flow of the predetermined service based on the prediction result.

In step 44, from SMF to AMF, based on SMF decision, response information for the request information for session management context establishment is returned, and/or the response information is updated. If session establishment is rejected, the response information will carry the rejection reason value of the response.

In step 45, if the PDU session uses dynamic Policy Control and Charging (PCC), then the SMF performs PCF selection; and otherwise, the SMF will execute local policies. The PDU session requests the XRM service and/or the multimodal service, and based on the application information provided by the subscription and the application function (AF), the SMF and PCF generate or activate corresponding XRM rules and/or multimodal data rules, or generate or activate enhanced data flow PCC rules that support XRM and multimodal sessions. For example, based on the capability indication information, scheduling optimization or selective volume controlling can be performed on downlink XRM data flow. Here, selective volume controlling can be active packet dropping triggered by events such as congestion.

The PCF or SMF generates corresponding policy rules and performs the predetermined operation on the downstream XRM data flow, where the predetermined operation includes scheduling optimization or selective volume control, which is transmitted to UPF for installation and execution. Where the optimization granularity of scheduling or volume controlling is data flow, PDU sets and/or data packages. The conditions for performing can be at least one of the following: performing the predetermined operation within a predetermined time window; performing the predetermined operation when volume of the data flow is greater than a volume threshold; or performing the predetermined operation when a packet loss rate is greater than a packet loss rate threshold. Where the prediction based on UPF can be network analysis (i.e., network congestion analysis) of NWDAF or event notifications (i.e., network congestion analysis) reported by RAN.

In step 46, the SMF returns N1 and N2 messages to the AMF, where the session management container of N1 message carries PDU session establishment acceptance information; where the session establishment acceptance information carries relevant QoS parameters that support XRM services and/or multimodal data services. In an embodiment, the session establishment acceptance information carries corresponding XRM rules and/or multimodal data rules, or QoS rules supporting XRM and multimodal data, for the terminal to associate XRM service data flow and performing QoS matching for XRM and multimodal data flow.

In step 47, from the AMF to the access network (AN)/the radio access network (RAN), the AMF transmits a NAS message to the radio access network (RAN), where the NAS message carries the PDU session ID and session acceptance message.

In step 48, from AN/RAN to UE, the RAN forwards the NAS message in step 47 to the terminal for execution.

In an embodiment, in the PDU session establishment procedure, the parameter information of the Protocol Configuration Option (PCO) carrying the capability indication information is transmitted to the first network function, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In order to better understand the embodiments of the present disclosure, the following will further illustrate the present disclosure through an embodiment.

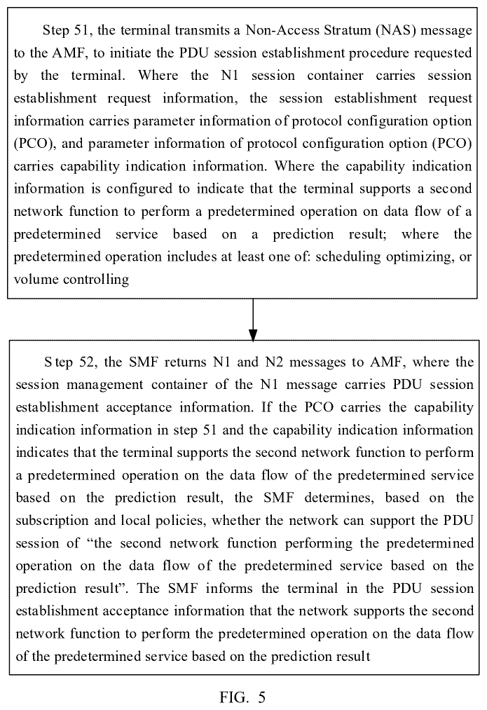

Referring to FIG. 5, in this embodiment, a data flow processing method is provided, which includes steps 51 to 52.

In step 51, the terminal transmits a Non-Access Stratum (NAS) message to the AMF, to initiate the PDU session establishment procedure requested by the terminal. Where the N1 session container carries session establishment request information, the session establishment request information carries parameter information of protocol configuration option (PCO), and parameter information of protocol configuration option (PCO) carries capability indication information. Where the capability indication information is configured to indicate that the terminal supports a second network function to perform a predetermined operation on data flow of a predetermined service based on a prediction result; where the predetermined operation includes at least one of: scheduling optimizing, or volume controlling.

In step 52, the SMF returns N1 and N2 messages to AMF, where the session management container of the N1 message carries PDU session establishment acceptance information. If the PCO carries the capability indication information in step 51 and the capability indication information indicates that the terminal supports the second network function to perform a predetermined operation on the data flow of the predetermined service based on the prediction result, the SMF determines, based on the subscription and local policies, whether the network can support the PDU session of “the second network function performing the predetermined operation on the data flow of the predetermined service based on the prediction result”. The SMF informs the terminal in the PDU session establishment acceptance information that the network supports the second network function to perform the predetermined operation on the data flow of the predetermined service based on the prediction result.

It should be noted that those skilled in the art can understand that the methods provided in embodiments of the present disclosure can be executed separately or together with some methods in embodiments of the present disclosure or related arts.

As shown in FIG. 6, this embodiment provides a data flow processing method, where the method is performed by a terminal, and the method includes step 61.

In step 61, capability indication information is transmitted to the first network function in the packet data unit (PDU) session modification procedure, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

The description of step 21 can be referred to for the explanation of step 61, which will not be repeated here.

It should be noted that those skilled in the art can understand that the methods provided in embodiments of the present disclosure can be executed separately or together with some methods in embodiments of the present disclosure or related arts.

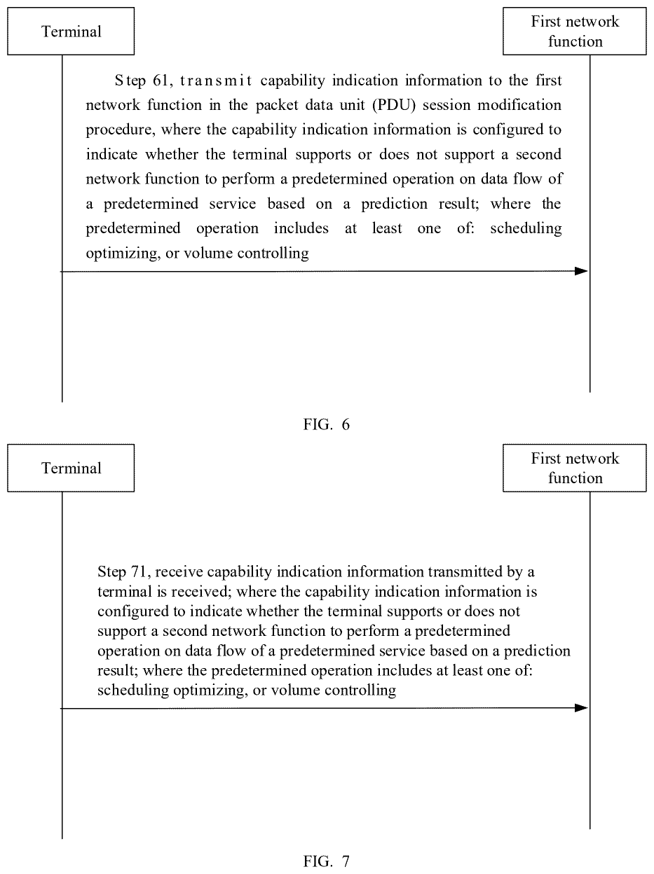

As shown in FIG. 7, this embodiment provides a data flow processing method, where the method is performed by a first network function, and the method includes step 71.

In step 71, capability indication information transmitted by a terminal is received. Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network device referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in a core network. For example, the first network function can be a Session Management Function (SMF) or a Policy Control Function (PCF), the second network function can be a User Plane Function (UPF), and the third network function can be an Access and Mobility Management Function (AMF). The network function can also be other evolved network functions, which is not limited here.

In an embodiment, the predetermined service includes an Extended Reality and Media (XRM) service or a multimodal service.

In an embodiment, the prediction result may be a size of a predicted amount of data to be transmitted or that needs to be transmitted within a predetermined period of time. It should be noted that when the size of the predicted amount of data exceeds the set threshold, scheduling optimizing and/or volume controlling need to be performed to improve the transmission efficiency of the data flow and alleviate congestion. In some embodiments, when the size of the predicted amount of data is smaller than the set threshold, scheduling optimizing and/or volume controlling may not be performed.

In an embodiment, the prediction result may be the prediction analysis result of Network Data Analytic Function (NWDAF). Alternatively, the prediction result may also be the event notification result reported by the radio access network.

In an embodiment, scheduling optimizing may prioritize scheduling data flow with an importance level greater than a level threshold. For example, if the data flow includes a first data flow and a second data flow, and the importance level of the first data flow is greater than the importance level of the second data flow, in the event of network congestion, the first data flow can be prioritized for scheduling. In some embodiments, scheduling optimizing can also include other methods, such as discarding unimportant packets and increasing transmission resources, which is not limited here.

In an embodiment, volume controlling may include controlling the volume of data flow when network congestion occurs. For example, when the congestion degree is greater than a degree threshold, the volume of the transmitted data flow is decreased. When the congestion degree is less than the degree threshold, the volume of the transmitted data flow is increased. In some embodiments, volume controlling can also include other methods. For example, when congestion occurs, active packet dropping can be triggered.

In an embodiment, the capability indication information transmitted by the terminal is received, where the capability indication information is configured to indicate whether the terminal supports or does not support a second network function to perform a predetermined operation on downlink data flow of a predetermined service based on a prediction result; where the predetermined operation includes at least one of: scheduling optimizing, or volume controlling.

In an embodiment, the capability indication information transmitted by the terminal is received via the base station and the third network function; where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the session procedure, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. It should be noted that in the session establishment or session modification procedure of the session procedure, the instruction information transmitted by the terminal needs to be received from the radio access network via the third network function. Here, the first network function may be SMF, and the third network function may be AMF.

In an embodiment, in the PDU session establishment procedure, the capability indication information transmitted by the terminal is received; where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, the capability indication information transmitted by the terminal is received in a PDU session modification procedure. Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the PDU session procedure, the parameter information of the session management core network (SM CN) capability carrying the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling; where the first network function includes a Session Management Function (SMF).

In an embodiment, in the PDU session procedure, the parameter information of protocol configuration option (PCO) carrying the capability indication information transmitted by the terminal is received; where the capability indication information is configured to indicate whether the terminal supports or does not support a second network function to perform a predetermined operation on data flow of a predetermined service based on a prediction result; where the predetermined operation includes at least one of: scheduling optimizing, or volume controlling; where the first network function includes a Session Management Function (SMF).

In an embodiment, the capability indication information transmitted by the terminal is received via the Session Management Function (SMF); where the first network function includes the Policy Control Function (PCF), where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. The PCF can formulate polices but not limited to polices for executing predetermined operations based on the capability indication information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. The predetermined operation is performed based on the policy rule information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. At least one of the following information is transmitted to the second network function: filtering rule information; usage monitoring rule information; or policy rule information.

It should be noted that those skilled in the art can understand that the methods provided in embodiments of the present disclosure can be executed separately or together with some methods in embodiments of the present disclosure or related arts.

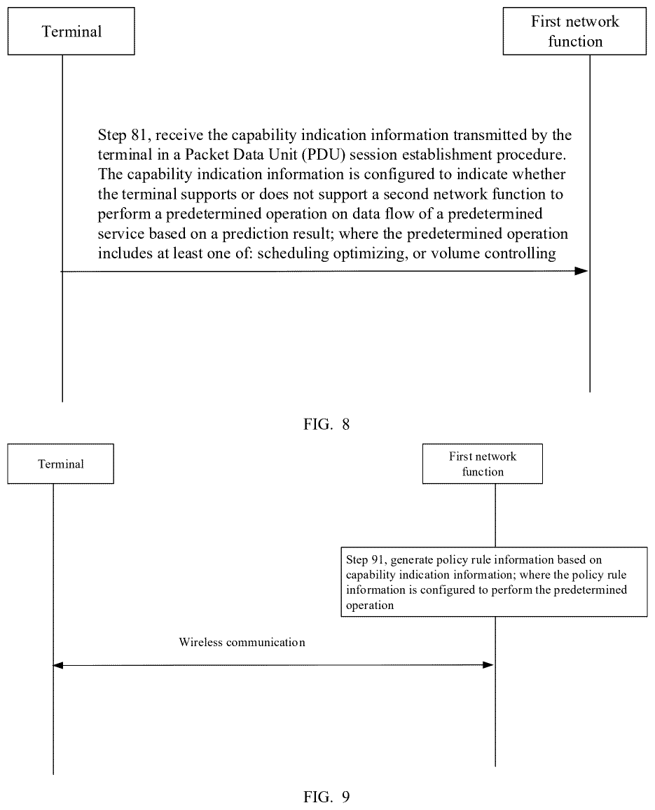

As shown in FIG. 8, this embodiment provides a data flow processing method, where the method is performed by a first network function, and the method includes step 81.

In step 81, the capability indication information transmitted by the terminal is received in a Packet Data Unit (PDU) session establishment procedure. The capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the PDU session establishment procedure, the parameter information of the session management core network (SM CN) capability carrying the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

In an embodiment, in the PDU session establishment procedure, the parameter information of the Protocol Configuration Option (PCO) carrying the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

For a better understanding of the embodiments of the present disclosure, the description in steps 41 to 48 and steps 51 to 52 can be referred to.

It should be noted that those skilled in the art can understand that the methods provided in embodiments of the present disclosure can be executed separately or together with some methods in embodiments of the present disclosure or related arts.

As shown in FIG. 9, this embodiment provides a data flow processing method, where the method is performed by a first network function, and the method includes step 91.

In step 91, policy rule information is generated based on capability indication information; where the policy rule information is configured to perform the predetermined operation.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. performing the predetermined operation based on the policy rule information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. The predetermined operation is performed based on the policy rule information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. At least one of the following information is transmitted to the second network function: filtering rule information; usage monitoring rule information; or policy rule information.

In an embodiment, in the PDU set based QoS handling procedure, the policy rule information is generated based on the capability indication information; where the policy rule information is configured to perform the predetermined operation. It should be noted that the PDU set based QoS handling procedure can be executed in the PDU session establishment procedure or in the PDU session modification procedure.

It should be noted that if monitoring and reporting of prediction conditions is performed for a radio access network, in the PDU set based QoS handling procedure, when a packet loss triggering event (such as a congestion degree greater than a threshold, a packet loss rate greater than a threshold, a latency greater than a threshold, or UE status related requirements, etc.) is detected, the radio access network reports a packet loss event and/or indication in the PDU set based QoS handling procedure to the core network, to enable the first network function to generate and update corresponding rules, where the rules include policy rule information.

In an embodiment, the PDU set based QoS handling packets dropping events indicates the triggering conditions of XRM service downlink volume eligible dropping, such as congestion and terminal state requirements (such as overheating, battery, power mode, and GPU (Graphics Processing Unit) load balance).

It should be noted that those skilled in the art can understand that the methods provided in embodiments of the present disclosure can be executed separately or together with some methods in embodiments of the present disclosure or related arts.

As shown in FIG. 10, this embodiment provides a data flow processing method, where the method is performed by a first network function, and the method includes step 101.

In Step 101, a predetermined operation is performed based on the policy rule information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. The predetermined operation is performed based on the policy rule information.

It should be noted that those skilled in the art can understand that the methods provided in embodiments of the present disclosure can be executed separately or together with some methods in embodiments of the present disclosure or related arts.

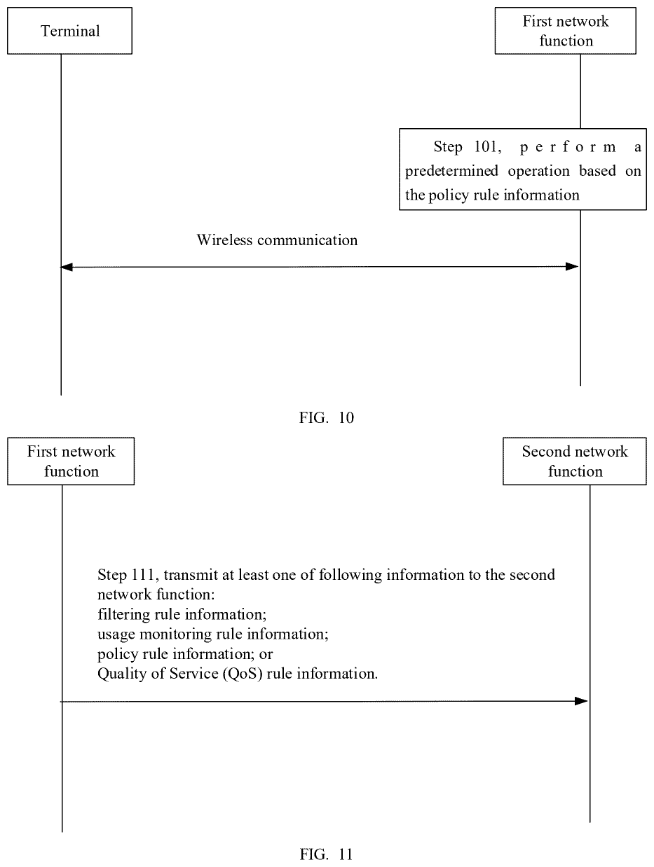

As shown in FIG. 11, this embodiment provides a data flow processing method, where the method is performed by a first network function, and the method includes step 111.

In Step 111, at least one of following information is transmitted to the second network function: filtering rule information; usage monitoring rule information; policy rule information; or Quality of Service (QoS) rule information.

In an embodiment, the capability indication information transmitted by the terminal is received, where the capability indication information is configured to indicate whether the terminal supports or does not support a second network function to perform a predetermined operation on data flow of a predetermined service based on a prediction result; where the predetermined operation includes at least one of: scheduling optimizing, or volume controlling. Policy rule information is generated based on the capability indication information; where the policy rule information is configured to perform the predetermined operation. At least one of the following information is transmitted to the second network function: filtering rule information, usage monitoring rule information, or policy rule information.

It should be noted that those skilled in the art can understand that the methods provided in embodiments of the present disclosure can be executed separately or together with some methods in embodiments of the present disclosure or related arts.

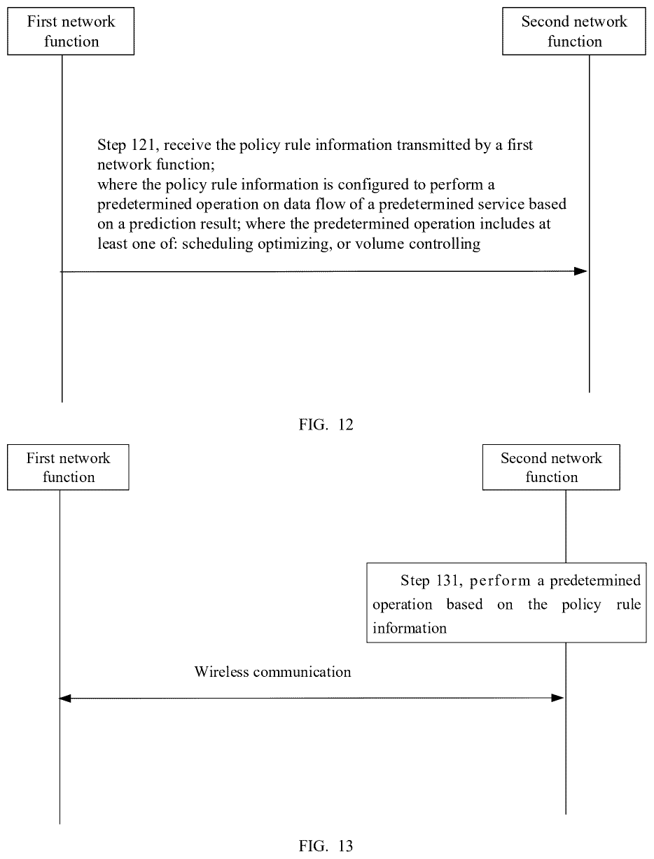

As shown in FIG. 12, this embodiment provides a data flow processing method, where the method is performed by a second network function, and the method includes step 121.

In step 121, the policy rule information transmitted by a first network function is received; where the policy rule information is configured to perform a predetermined operation on data flow of a predetermined service based on a prediction result; where the predetermined operation includes at least one of: scheduling optimizing, or volume controlling.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network device referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in a core network. For example, the first network function can be a Session Management Function (SMF) or a Policy Control Function (PCF), the second network function can be a User Plane Function (UPF), and the third network function can be an Access and Mobility Management Function (AMF). The network function can also be other evolved network functions, which is not limited here.

In an embodiment, the predetermined service includes an Extended Reality and Media (XRM) service or a multimodal service.

In an embodiment, the prediction result may be a size of a predicted amount of data to be transmitted or that needs to be transmitted within a predetermined period of time. It should be noted that when the size of the predicted amount of data exceeds the set threshold, scheduling optimizing and/or volume controlling need to be performed to improve the transmission efficiency of the data flow and alleviate congestion. In some embodiments, when the size of the predicted amount of data is smaller than the set threshold, scheduling optimizing and/or volume controlling may not be performed.

In an embodiment, the prediction result may be the prediction analysis result of Network Data Analytic Function (NWDAF). Alternatively, the prediction result may also be the event notification result reported by the radio access network.

In an embodiment, scheduling optimizing may prioritize scheduling data flow with an importance level greater than a level threshold. For example, if the data flow includes a first data flow and a second data flow, and the importance level of the first data flow is greater than the importance level of the second data flow, in the event of network congestion, the first data flow can be prioritized for scheduling. In some embodiments, scheduling optimizing can also include other methods, such as discarding unimportant packets and increasing transmission resources, which is not limited here.

In an embodiment, volume controlling may include controlling the volume of data flow when network congestion occurs. For example, when the congestion degree is greater than a degree threshold, the volume of the transmitted data flow is decreased. When the congestion degree is less than the degree threshold, the volume of the transmitted data flow is increased. In some embodiments, volume controlling can also include other methods. For example, when congestion occurs, active packet dropping can be triggered.

In an embodiment, policy rule information transmitted by the first network function is received; where the policy rule information is configured to perform a predetermined operation on data flow of a predetermined service based on a prediction result; where the predetermined operation includes at least one of: scheduling optimizing, or volume controlling. performing the predetermined operation based on the policy rule information.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed at a granularity of predetermined units; where the predetermined units include data flow, PDU sets, or data packets.

In an embodiment, policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed within a predetermined time window.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed in response to determining that volume of the data flow is greater than a volume threshold.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed in response to determining that a packet loss rate is greater than a packet loss rate threshold.

It should be noted that those skilled in the art can understand that the methods provided in embodiments of the present disclosure can be executed separately or together with some methods in embodiments of the present disclosure or related arts.

As shown in FIG. 13, this embodiment provides a data flow processing method, where the method is performed by a second network function, and the method includes step 131.

In step 131, a predetermined operation is performed based on the policy rule information.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. performing the predetermined operation based on the policy rule information.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed based on the policy rule information, in the PDU session establishment procedure or PDU session modification procedure.

It should be noted that those skilled in the art can understand that the methods provided in embodiments of the present disclosure can be executed separately or together with some methods in embodiments of the present disclosure or related arts.

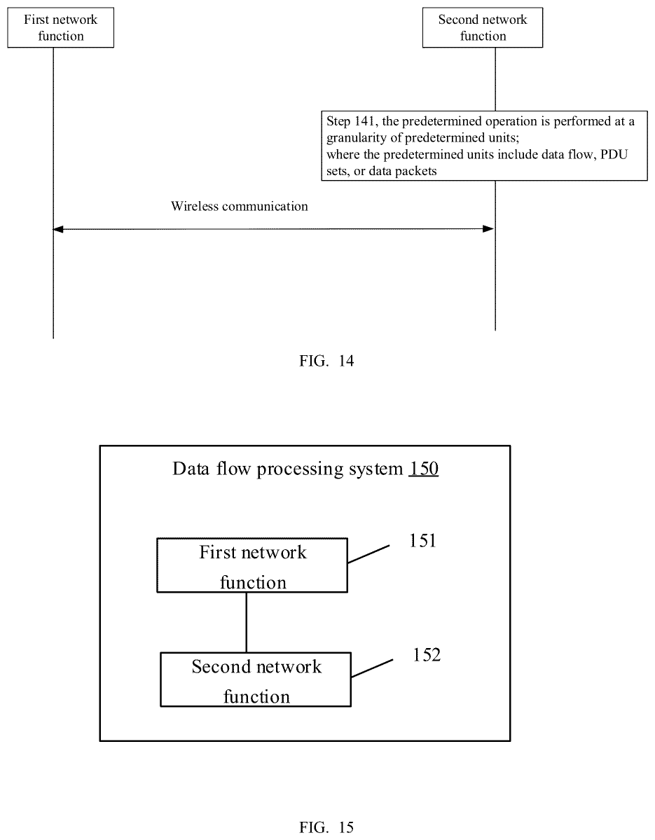

As shown in FIG. 14, this embodiment provides a data flow processing method, where the method is performed by a second network function, and the method includes step 141.

In step 141, the predetermined operation is performed at a granularity of predetermined units; where the predetermined units include data flow, PDU sets, or data packets.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed at a granularity of predetermined units; where the predetermined units include data flow, PDU sets, or data packets.

In an embodiment, policy rule information transmitted by the first network function is received; where the policy rule information is configured to perform a predetermined operation on data flow of a predetermined service based on a prediction result; where the predetermined operation includes at least one of: scheduling optimizing, or volume controlling. In the PDU session establishment procedure or PDU session modification procedure, the predetermined operation is performed at a granularity of predetermined units; where the predetermined units include data flow, PDU sets, or data packets.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed within a predetermined time window.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed in response to determining that volume of the data flow is greater than a volume threshold.

In an embodiment, the policy rule information transmitted by the first network function is received; where the policy rule information is configured to perform a predetermined operation on data flow of a predetermined service based on a prediction result; where the predetermined operation includes at least one of: scheduling optimizing, or volume controlling. The predetermined operation is performed in response to determining that a packet loss rate is greater than a packet loss rate threshold.

It should be noted that those skilled in the art can understand that the methods provided in embodiments of the present disclosure can be executed separately or together with some methods in embodiments of the present disclosure or related arts.

As shown in FIG. 15, the embodiments of the present disclosure provide a data flow processing system 150, where the system 150 includes a first network function 151 and a second network function 152. Where the first network function 151 performs any one of the methods performed by the first network function 151 in the present disclosure. The second network function 152 performs any one of the methods performed by the second network function 152 in the present disclosure.

It should be noted that those skilled in the art can understand that the methods provided in embodiments of the present disclosure can be executed separately or together with some methods in embodiments of the present disclosure or related arts.

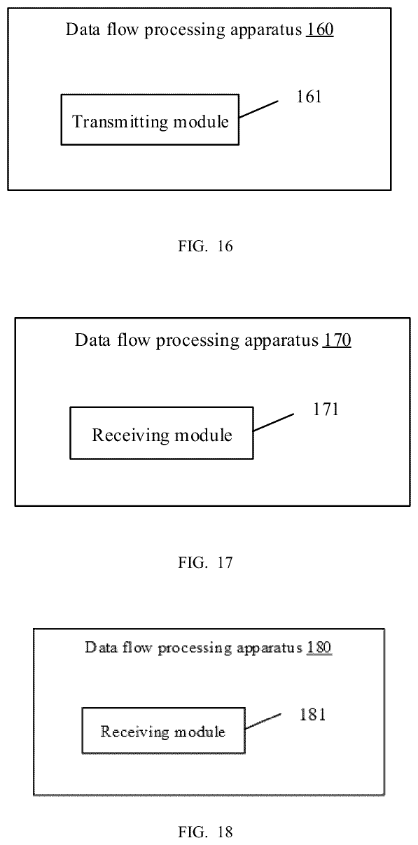

As shown in FIG. 16, the embodiments of the present disclosure provide a data flow processing apparatus 160, where the apparatus 160 includes a transmitting module 161.

The transmitting module 161 is configured to transmit capability indication information to a first network function.

Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

It should be noted that those skilled in the art can understand that the methods provided in embodiments of the present disclosure can be executed separately or together with some methods in embodiments of the present disclosure or related arts.

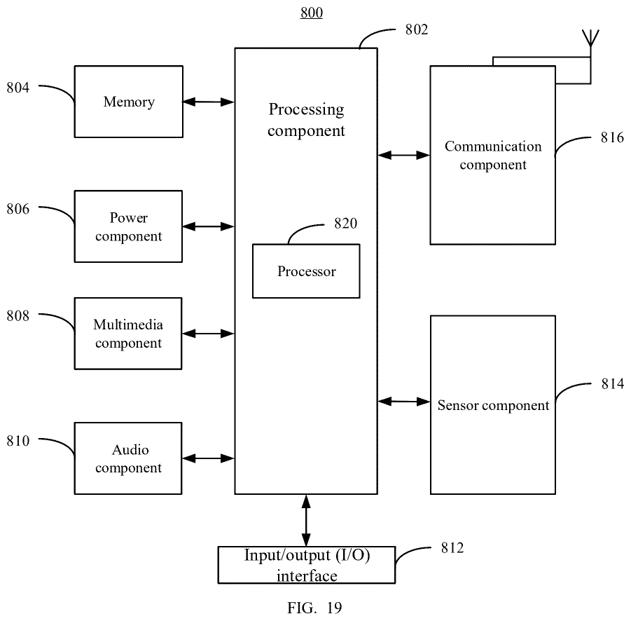

As shown in FIG. 17, the embodiments of the present disclosure provide a data flow processing apparatus 170, where the apparatus includes a receiving module 171.

The receiving module 171 is configured to receive capability indication information transmitted by a terminal.

Where the capability indication information is configured to indicate whether the terminal supports or does not support a second network function to perform a predetermined operation on data flow of a predetermined service based on a prediction result; where the predetermined operation includes at least one of: scheduling optimizing, or volume controlling.

It should be noted that those skilled in the art can understand that the methods provided in embodiments of the present disclosure can be executed separately or together with some methods in embodiments of the present disclosure or related arts.

As shown in FIG. 18, the embodiments of the present disclosure provide a data flow processing apparatus 180, where the apparatus 180 includes a receiving module 181.

The receiving module 181 is configured to receive policy rule information transmitted by a first network function.

Where the policy rule information is configured to perform a predetermined operation on data flow of a predetermined service based on a prediction result; where the predetermined operation includes at least one of: scheduling optimizing, or volume controlling.

It should be noted that those skilled in the art can understand that the methods provided in embodiments of the present disclosure can be executed separately or together with some methods in embodiments of the present disclosure or related arts.

The embodiments of the present disclosure provide a communication device including: one or more processors; and one or more memories storing instructions executable by the processor. Where the one or more processors are configured to execute the executable instructions to implement the method according to any one of the embodiments of the present disclosure.

The processor may include various types of storage media, which are non-transitory computer-readable storage media that can continue to retain information stored thereon after the communication device loses power.

The processor may be connected to the memory via a bus or the like, and may be used to read an executable program stored in the memory.

The embodiments of the present disclosure further provide a computer storage medium, where the computer storage medium stores a computer executable program, where when the executable program is performed by one or more processors, the method according to any one of the embodiments of the present disclosure is implemented.

Regarding the apparatuses in the examples, the specific manner in which each module performs operations has been described in detail in the examples of the methods, and will not be described in detail here.

As shown in FIG. 19, an embodiment of the present disclosure provides a structure of a terminal.

Referring to FIG. 19, this embodiment provides a terminal 800, which can be a mobile phone, a computer, a digital broadcast terminal, a message transceiving device, a game console, a tablet device, a medical device, a fitness device and a personal digital assistant and etc.

Referring to FIG. 19, the terminal 800 can include one or more of the following components: processing component 802, memory 804, power component 806, multimedia component 808, audio component 810, input/output (I/O) interface 812, sensor component 814, or a communication component 816.

The processing component 802 generally controls overall operations of the terminal 800, such as operations associated with display, phone calls, data communications, camera operations, and recording operations. The processing assembly 802 may include one or more processors 820 to execute instructions to complete all or a part of the blocks of the described methods. Further, the processing component 802 may include one or more modules to facilitate interaction between the processing component 802 and another component. For example, the processing component 802 may include a multimedia module to facilitate the interaction between the multimedia component 808 and the processing component 802.

The memory 804 is configured to store different types of data to support operations at the terminal 800. Examples of such data include instructions for any application or method operated on the terminal 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 806 supplies power for different components of the terminal 800. The power supply component 806 can include a power supply management system, one or more power supplies, and other components associated with generating, managing and distributing power for the terminal 800.

The multimedia component 808 includes a screen providing an output interface between the terminal 800 and the user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense the boundary of a touch or slide operation but also detect duration and pressure relating to the touch or slide operation. In some examples, the multimedia component 808 may include a front camera and/or a rear camera. When the apparatus 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signaling. For example, the audio component 810 includes a microphone (MIC). When the terminal 800 is in an operating mode, such as a call mode, a record mode and a voice recognition mode, the microphone is to receive an external audio signal. The received audio signaling may be further stored in the memory 804 or transmitted via the communication component 816. In some examples, the audio component 810 also includes a loudspeaker for outputting an audio signal.

The I/O interface 812 may provide an interface between the processing component 802 and peripheral interface modules. The peripheral interface modules may include a keyboard, a click wheel, buttons and so on. These buttons may include but not limited to, a home button, a volume button, a start button and a lock button.

The sensor component 814 includes one or more sensors to provide status assessments of various aspects for the terminal 800. For example, the sensor component 814 may detect an on/off state of the terminal 800 and a relative location of components. For example, the components are a display and a keypad of the terminal 800. The sensor component 814 may also detect a position change of the terminal 800 or a component of the terminal 800, presence or absence of a touch of a user on the terminal 800, an orientation or acceleration/deceleration of the terminal 800, and a temperature change of terminal 800. The sensor component 814 may include a proximity sensor for detecting the existence of a nearby object without any physical touch. The sensor component 814 may also include an optical sensor, such as a CMOS or CCD image sensor used in an imaging application. In some examples, the sensor component 814 may also include an acceleration sensor, a gyro sensor, a magnetic sensor, a pressure sensor, or a temperature sensor.

The communication component 816 is to facilitate wired or wireless communication between the terminal 800 and other devices. The terminal 800 can access a wireless network according to a communication standard, such as Wi-Fi, 2G or 3G, or any combination thereof. In some embodiments, the communication component 816 may receive a broadcast signal or broadcast-related information from an external broadcast management system via a broadcast channel. In some embodiments, the communication assembly 816 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the terminal 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the method described.

In an example, a non-transitory computer readable storage medium including instructions, such as the memory 804 including instructions, is also provided. The instructions may be performed by the processor 820 of the terminal 800 to complete any of the methods. For example, the non-transitory computer-readable storage medium may be a ROM, a RAM, a CD-ROM, a magnetic tape, a floppy disc, an optical data storage device, and the like.

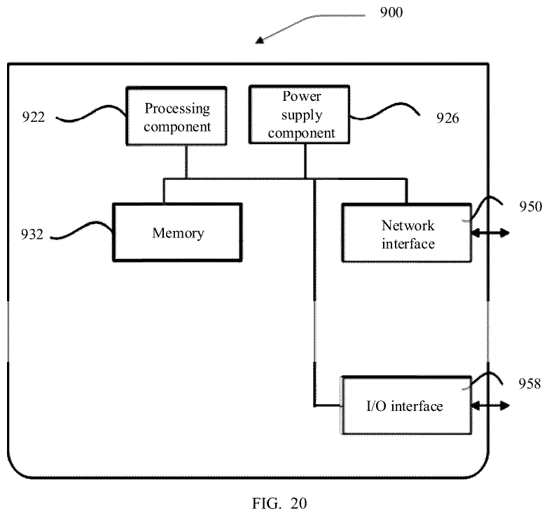

As shown in FIG. 20, a structure of a base station is illustrated in an embodiment of the present disclosure. For example, the base station 900 may be provided as a network device. Referring to FIG. 20, the base station 900 includes a processing component 922, which further includes one or more processors, and a memory resource represented by a memory 932 for storing instructions, such as applications, that can be performed by the processing component 922. The application stored in the memory 932 may include one or more modules and each module corresponds to a set of instructions. In addition, the processing component 922 is configured to execute instructions to perform any one of the methods applied to the base station.

The base station 900 may also include a power supply component 926 configured to perform power management of the base station 900, a wired or wireless network interface 950 configured to connect the base station 900 to the network, and an input-output (I/O) interface 958. The base station 900 can operate an operating system stored in the memory 932, such as Windows Server™, Mac OS X™, Unix™, Linux™, FreeBSD™, or the like.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described and shown in the accompanying drawings and may be modified or changed without departing from the scope of the present disclosure. The scope of protection of the present disclosure is limited only by the appended claims.

1. A data flow processing method, performed by a terminal, comprising:
transmitting capability indication information to a first network function,
wherein the capability indication information is configured to indicate whether the terminal supports or does not support a second network function to perform a predetermined operation on data flow of a predetermined service based on a prediction result, and
wherein the predetermined operation comprises at least one of: scheduling optimizing, or volume controlling.

2. The method according to claim 1, wherein transmitting the capability indication information to the first network function comprises:
transmitting the capability indication information to the first network function in a Packet Data Unit (PDU) session establishment procedure;
or,
transmitting the capability indication information to the first network function in a PDU session modification procedure.

3. The method according to claim 1, wherein transmitting the capability indication information to the first network function comprises:
transmitting parameter information of a Session Management Core Network (SM CN) capability carrying the capability indication information to the first network function;
or,
transmitting parameter information of a Protocol Configuration Option (PCO) carrying the capability indication information to the first network function; wherein the first network function comprises a Session Management Function (SMF).

4. The method according to claim 1, wherein transmitting the capability indication information to the first network function comprises:
transmitting the capability indication information to the first network function via a Session Management Function (SMF), and
wherein the first network function comprises a Policy Control Function (PCF).

5. The method according to claim 1, wherein
the predetermined service comprises an Extended Reality and Media (XRM) service or a multimodal service,
the first network function comprises a Policy Control Function (PCF) or a Session Management Function (SMF), and
the second network function comprises a User Plane Function (UPF).

6. (canceled)

7. The method according to claim 1, wherein transmitting the capability indication information to the first network function comprises:
transmitting the capability indication information to the first network function via a base station and a third network function, and
wherein the third network function comprises an Access and Mobility Management Function (AMF).

8. (canceled)

9. A data flow processing method, performed by a first network function, comprising:
receiving capability indication information transmitted by a terminal,
wherein the capability indication information is configured to indicate whether the terminal supports or does not support a second network function to perform a predetermined operation on data flow of a predetermined service based on a predicted result, and
wherein the predetermined operation comprises at least one of: scheduling optimizing, or volume controlling.

10. The method according to claim 9, wherein receiving the capability indication information transmitted by the terminal comprises:
receiving the capability indication information transmitted by the terminal in a Packet Data Unit (PDU) session establishment procedure;
or,
receiving the capability indication information transmitted by the terminal in a PDU session modification procedure.

11. The method according to claim 9, wherein receiving the capability indication information transmitted by the terminal comprises:
receiving parameter information of a Session Management Core Network (SM CN) capability carrying the capability indication information transmitted by the terminal;
or,
receiving parameter information of a Protocol Configuration Option (PCO) carrying the capability indication information transmitted by the terminal; wherein the first network function comprises a Session Management Function (SMF).

12. The method according to claim 9, wherein receiving the capability indication information transmitted by the terminal comprises:
receiving the capability indication information transmitted by the terminal via a Session Management Function (SMF), wherein the first network function comprises a Policy Control Function (PCF); or
receiving the capability indication information transmitted by the terminal via a base station and a third network function, wherein the third network function comprises an Access and Mobility Management Function (AMF).

13. The method according to claim 9, further comprising:
generating policy rule information based on the capability indication information; wherein the policy rule information is configured to perform the predetermined operation; and
performing the predetermined operation based on the policy rule information.

14. (canceled)

15. The method according to claim 13, further comprising:
transmitting at least one of following information to the second network function:
filtering rule information;
usage monitoring rule information;
policy rule information; or
Quality of Service (QoS) rule information, and
wherein the second network function comprises a User Plane Function (UPF).

16. (canceled)

17. The method according to claim 9, wherein
the predetermined service comprises an Extended Reality and Media (XRM) service or a multimodal service, and
the first network function comprises a Policy Control Function (PCF) or a Session Management Function (SMF); and the second network function comprises a User Plane Function (UPF).

18.-20. (canceled)

21. A data flow processing method, performed by a second network function, comprising:
receiving policy rule information transmitted by a first network function,
wherein the policy rule information is configured to perform a predetermined operation on data flow of a predetermined service based on a prediction result, and
wherein the predetermined operation comprises at least one of: scheduling optimizing, or volume controlling.

22. The method according to claim 21, further comprising:
performing the predetermined operation based on the policy rule information.

23. (canceled)

24. The method according to claim 22, wherein performing the predetermined operation based on the policy rule information comprises at least one of:
performing the predetermined operation at a granularity of predetermined units;
wherein the predetermined units comprise data flow, Packet Data Unit (PDU) sets, or data packets;
performing the predetermined operation within a predetermined time window;
performing the predetermined operation in response to determining that volume of the data flow is greater than a volume threshold; or
performing the predetermined operation in response to determining that a packet loss rate is greater than a packet loss rate threshold.

25. The method according to claim 21, wherein the prediction result is a prediction analysis result of at least one of a network data analytic function (NWDAF) or an event notification result reported by a radio access network.

26. A data flow processing system, comprising:
a first network function; and
a second network function,
wherein the first network function performs a data flow processing method including:
receiving capability indication information transmitted by a terminal, and
wherein the capability indication information is configured to indicate whether the terminal supports or does not support a second network function to perform a predetermined operation on data flow of a predetermined service based on a predicted result; wherein the predetermined operation comprises at least one of: scheduling optimizing, or volume controlling, and
wherein the second network function performs the method according to claim 21.

27.-29. (canceled)

30. A communication device, comprising:
an antenna;
one or more memories; and
one or more processors connected to the antenna and the one or more memories, wherein the one or more processors are configured to, by executing computer executable instructions stored on the one or more memories, control transmission and reception of the antenna, implement the method according to claim 1.

31. A computer storage medium storing computer executable instructions, wherein one or more processors execute the computer executable instructions to implement the method according to claim 1.
